(19) United States
(12) Patent Application Publication
(10) Pub. No.: US 2006/0082906 A1
(43) Pub. Date: Apr. 20, 2006

(54) Projector structure

(76) Inventor: Fu-To Wang, Huwei Township (TW)

Correspondence Address: BRUCE H. TROXELL, SUITE 1404, 5205 LEESBURG PIKE, FALLS CHURCH, VA, 22041, US

(21) Appl. No.: 10/968,242

(22) Filed: Oct. 20, 2004

(51) Int. Cl. G02B 27/02

(52) U.S. Cl. 359/798

(57) ABSTRACT

A projector structure including a main body in which two brackets are fixed. Each bracket has a rest recess. One of the brackets has a panel on which a motor and a driving gear are mounted. A cover is detachably disposed on outer face of the main body. A pair of grasping arms inward extends from inner side of the cover for detaining a reel of a film in the rest recesses. A first and a second rotary discs with different pictures are fixedly fitted on the reel of the film. The film has a driven gear engaged with the driving gear. When driven, the first and second rotary discs are rotated in reverse directions, whereby the pictures of the rotary discs interflow to present a special visual effect. The projector structure further includes a rearward displaceable push section for pushing the film and making the reel of the film leave the brackets for replacing the film.

### BACKGROUND OF THE INVENTION

The present invention is related to an improved projector structure, and more particularly to a projector in which the film is replaceable and the pictures can interflow to present a special dynamic visual effect.

A conventional projector includes a projecting light, a projective article and a focusing unit which are arranged in a main body of the projector. The light projected by the projecting light penetrates through the projective article or is reflected by the projective article and then is focused by the focusing unit and projected onto a screen or plane wall outside of the main body to present an image. Taiwanese Patent Publication No. 189070 discloses a projecting clock having a light seat disposed in a housing. A projecting light is seated in the light seat. The projecting clock further includes a focusing lens frame perpendicular to the light seat, a focusing lens fixedly disposed at the center of the focusing lens frame and a clock formed of a mirror positioned in the housing at rear end thereof. When the projecting light emits light, the focusing lens focuses the light and projects the light to the clock. The light is then reflected toward a diverging lens. The light passes through diverging holes to project the clock face to a wall so as to show the time. Taiwanese Patent Publication No. 245348 discloses a projector for showing a clock. The projector includes a main body and a support seat. The main body is composed of a bottom casing, an upper casing, a front cover and a rear cover. The bottom casing has a projecting space in which a light seat, a reflective plate, a focusing lens and a light through hole are disposed. The light emitted from the light seat is projected onto a bowl-shaped reflective body of the front cover. The light is reflected by the reflective body to pass through the light through hole and project onto the reflective plate. Then the light is reflected by the reflective plate to a first focusing lens and then to a second focusing lens. Then the light is projected out from a projecting opening.

The above projectors all are used to project static projective article or reflective article. An improved projector for projecting dynamic projective article or reflective article. An electric motor is added to the projective article or reflective article for driving the article to rotate so as to achieve a dynamic picture effect.

However, in the above dynamic projector, the projective article or reflective article cannot be replaced so that only monotonous dynamic picture effect is achieved.

### SUMMARY OF THE INVENTION

It is therefore a primary object of the present invention to provide an improved projector structure in which the projective article is replaceable and the pictures can interflow to present a special dynamic visual effect.

According to the above object, the projector structure of the present invention includes a main body in which two brackets are fixed. Each bracket has a rest recess. One of the brackets has a panel on which a motor and a driving gear are mounted. A cover is detachably disposed on outer face of the main body. A pair of grasping arms inward extends from inner side of the cover for detaining a reel of a film in the rest recesses. A first and a second rotary discs with different pictures are fixedly fitted on the reel of the film. The film has a driven gear engaged with the driving gear. When driven, the first and second rotary discs are rotated in reverse directions, whereby the pictures of the rotary discs interflow to present a special visual effect.

The projector structure further includes a rearward displaceable push section for pushing the film and making the reel of the film leave the brackets for replacing the film.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 is a perspective partially assembled view of the present invention;

FIG. 4 shows the engagement between the driven gear and driving gear of the transparent rotary discs of the present invention;

FIG. 5 shows the replacement of the film of the present invention; and

FIG. 6 shows the pictures of the films on the transparent rotary discs of the present invention.

### DETAILED DESCRIPTION OF THE PREFERRED EMBODIMENTS

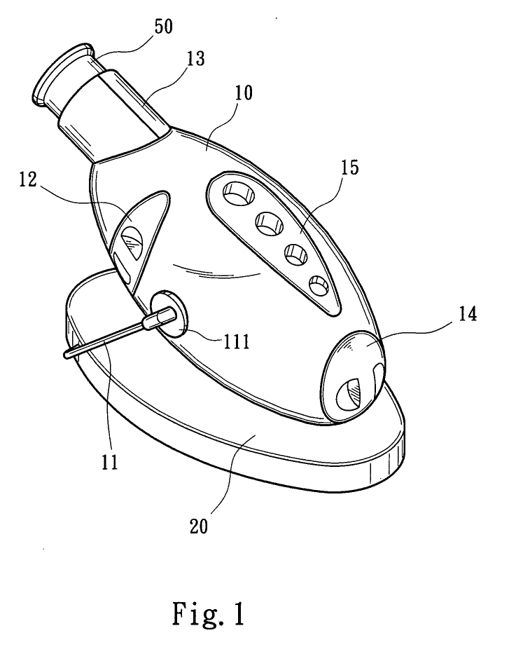

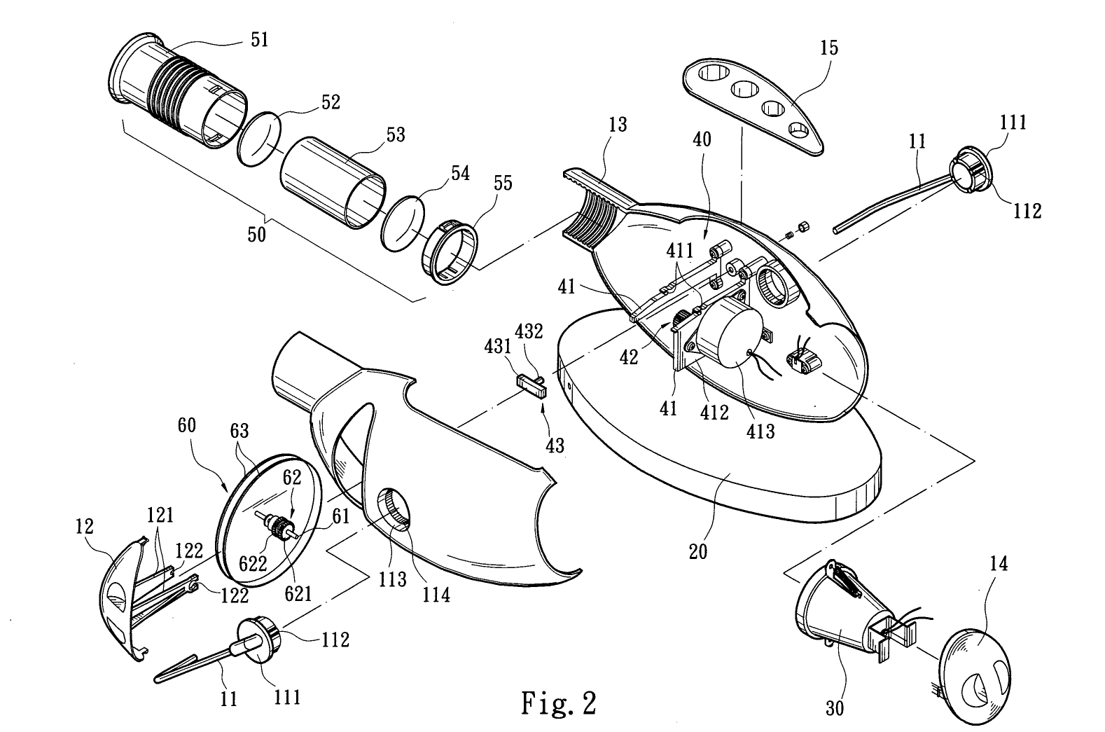

Please refer to FIGS. 1 and 2. The projector of the present invention includes a main body 10 and a base seat 20 pivotally connected with the main body 10 via a support member 11. The elevation of the main body 10 is adjustable. A film projecting mechanism is disposed in the main body 10. The film projecting mechanism includes a projecting light 30, a rotary unit 40 and a focusing unit 50. The rotary unit 40 includes two brackets 41 fixed on inner face of the wall of the main body 10. Each bracket 41 has a rest recess 411. One of the brackets 41 has a panel 412 on which a motor 413 and a driving gear 42 are mounted. A cover 12 is fixed on outer face of the wall of the main body 10. A pair of grasping arms 121 inward extends from inner side of the cover 12. A front end of each grasping arm 121 is formed with claws 122 for detaining a reel 61 of the film 60 and a driven gear 62 in the rest recess 411 of the bracket 41. The driven gear 62 is engaged with the driving gear 42. In this embodiment, a push section 43 having a suspension arm 431 is used to push the film 60. The push section 43 has an outer end 432 displaceably protruding from inner face of the wall of the main body 10 to outer side thereof. When an operator presses the outer end 432, the suspension arm 431 will push the reel 61 of the film 60 and the driven gear 62 to leave the bracket 41.

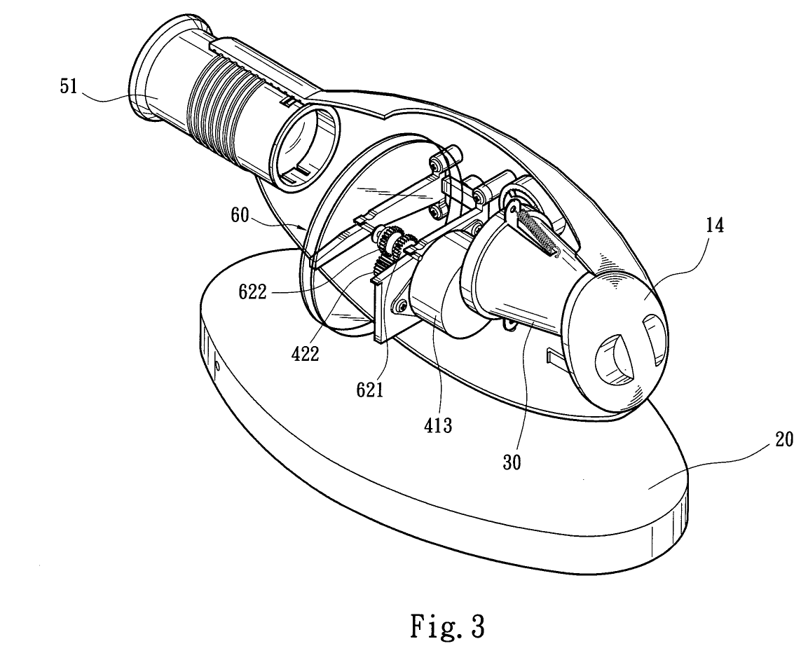

Referring to FIGS. 2 and 3, the projecting light 30 is connected on a rear cap 14 and mounted in rear section of the main body 10. A ventilating decorative cover 15 is disposed on upper side of the main body 10 for exchanging the hot air and ambient atmosphere. The focusing unit 50 includes a fitting head 51, a first focusing lens 52, a spacer sleeve 53, a second focusing lens 54 and a locating collar 55 which are sequentially assembled. The focusing unit 50 is installed in a projecting opening 13. One end of the support member 11 is pivotally connected on the base seat 20, while the other end of the support member 11 is formed with a rotary button 111. Multiple resilient ribs 112 are formed on the surface of the rotary button 111. The main body 10 is formed with a splined hole 113 having splines 114 on the circumference. The rotary button 111 is fitted in the splined hole 113 with the ribs 112 engaged with the splines 114. Accordingly, the rotary button 111 can be intermittently located to adjust the elevation of the main body 10.

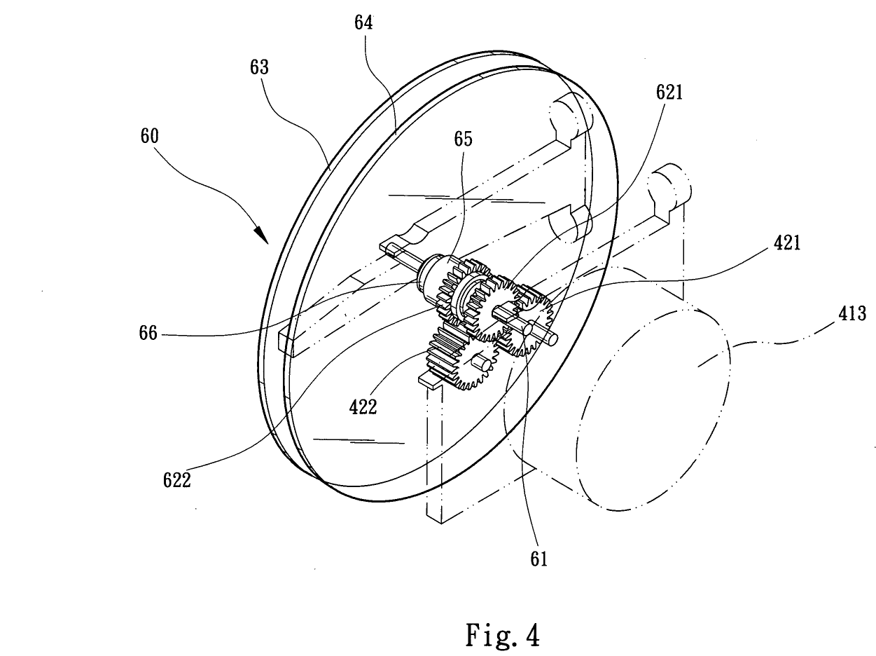

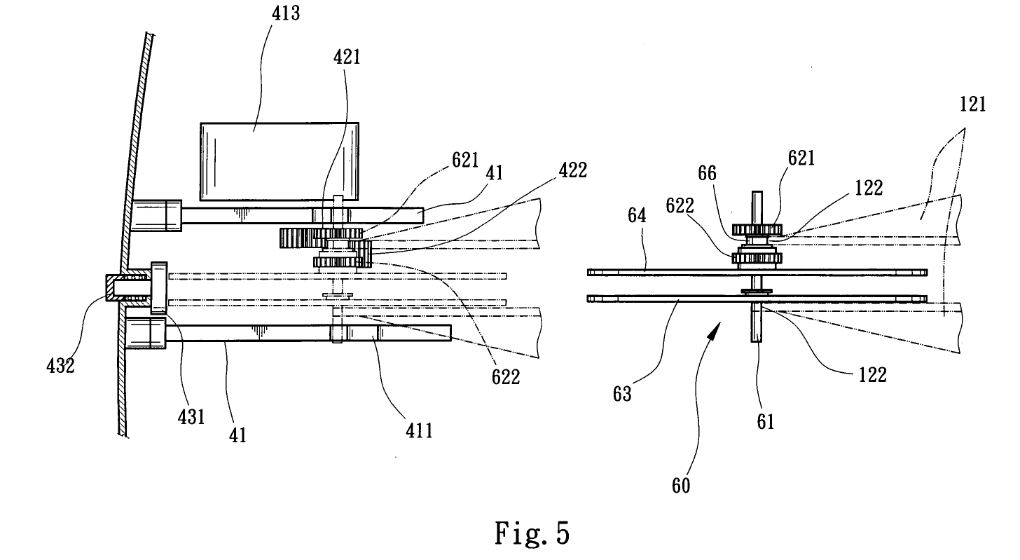

Referring to FIGS. 4 and 5, the driving gear 42 of the panel 412 includes an inner gear 421 and an outer gear 422. The inner gear 421 is rotatably fitted on the central shaft of the motor 413 for driving the outer gear 422. An outer gear 621, a first rotary disc 63 and a second rotary disc 64 are fixedly fitted on the reel 61 of the film 60. The rotary discs 63, 64 are transparent and have circular profile. In this embodiment, the first rotary disc 63 is fixed on the reel 61 and synchronously rotatable therewith. A bush 65 is freely rotatably fitted on the reel 61 between the first rotary disc 63 and the outer driven gear 621. The bush 65 has an inner driven gear 622. The second rotary disc 64 is fitted on the bush 65. The second rotary disc 64 and the first rotary disc 63 are asynchronously rotatable with each other. The first and second rotary discs 63, 64 are preferably spaced from each other by a set gap, whereby the two rotary discs 63, 64 can forward or backward rotate without interfering with each other.

Referring to FIG. 5, the inner and outer gears 421, 422 are respectively engaged with the outer driven gear 621 and inner driven gear 622 of the film 60. The film 60 is detained by the claws 122 of the pair of grasping arms 121. The reel 61 is inlaid in one of the claws 122, while a non-gear section 66 of the bush 65 is inlaid in the other of the claws 122. Therefore, the reel 61 of the film 60 is mounted in the rest recess 411 of the bracket 41 and the cover 12 is fixed on outer side of the main body 10. When replacing the film 60, the outer end 432 of the push member 43 is pressed to inward move the push member 43. At this time, the suspension arm 431 pushes the rotary discs 63, 64 of the film 60 to force the reel 61 to leave the rest recess 411 of the bracket 41. At the same time, the grasping arms 121 detaining the reel 61 are moved backward together with the reel 61. Therefore, the cover 12 can be opened for replacing the film 60. The above procedure can be repeated to install the film 60 into the main body 10.

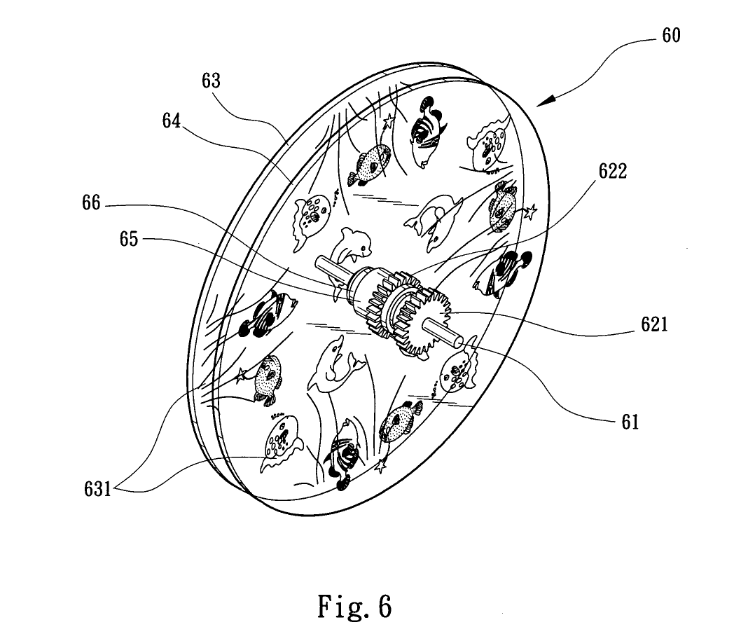

Referring to FIG. 6, various pictures 631 can be arranged on the first and second rotary discs 63, 64. When driven by the rotary unit 40, the first and second rotary discs 63, 64 are rotated in reverse directions, whereby the pictures 631 interflow with each other. Then the focusing unit 50 focuses the light projected by the projecting light 30 to project the image onto a screen outside the main body 10. For example, a funny dynamic image of fishes swimming between aquatic plants or butterflies flying between flowers can be created.

The above embodiments are only used to illustrate the present invention, not intended to limit the scope thereof. Many modifications of the above embodiments can be made without departing from the spirit of the present invention.

What is claimed is:

1. A projector structure comprising a main body and a base seat pivotally connected with the main body via a support member, the main body being adjustable in elevation, in the main body being mounted a motor, a driving gear and a film projecting mechanism including a projecting light, a rotary unit and a focusing unit, said projector structure being characterized in that the rotary unit includes:
two brackets fixed in the main body, each bracket having a rest recess, one of the brackets having a panel on which the motor and the driving gear are mounted;
a cover detachably disposed on outer face of the main body, a pair of grasping arms inward extending from inner side of the cover for detaining a reel of a film, whereby the reel can be rotated in the rest recess of the bracket; and
a rearward displaceable push section having a suspension arm for pushing the film and making the reel of the film leave the bracket.

2. The projector structure as claimed in claim 1, wherein the projecting light is connected with a rear cap which covers rear end of the main body.

3. The projector structure as claimed in claim 1, wherein the focusing unit includes a fitting head, a first focusing lens, a spacer sleeve, a second focusing lens and a locating collar which are sequentially assembled, the focusing unit being installed in a projecting opening.

4. The projector structure as claimed in claim 1, wherein the driving gear includes an inner gear and an outer gear, the inner gear being rotatably fitted on a central shaft of the motor for driving the outer gear.

5. The projector structure as claimed in claim 1, wherein an outer gear, a first rotary disc and a second rotary disc are fixedly fitted on the reel of the film, the rotary discs being transparent and having circular profile.

6. The projector structure as claimed in claim 5, wherein a bush is freely rotatably fitted on the reel between the first rotary disc and the outer driven gear, the bush having an inner driven gear.

7. The projector structure as claimed in claim 1, wherein the film is detained by the claws of a pair of grasping arms, the reel being inlaid in one of the claws, while a non-gear section of the bush being inlaid in the other of the claws.

8. The projector structure as claimed in claim 1, wherein a ventilating decorative cover is disposed on upper side of the main body, whereby hot air can flow out through the vents of the ventilating decorative cover to exchange for ambient atmosphere.

9. The projector structure as claimed in claim 1, wherein one end of the support member is pivotally connected on the base seat, while the other end of the support member is formed with a rotary button, multiple resilient ribs being formed on a surface of the rotary button, the main body being formed with a splined hole having splines on a circumference, the rotary button being fitted in the splined hole with the ribs engaged with the splines, whereby the rotary button can be intermittently located to adjust the elevation of the main body.
